(19) United States
(12) Patent Application Publication
(10) Pub. No.: US 2025/0165261 A1
(43) Pub. Date: May 22, 2025

(54) Method, System, and Computer Program Product for Managing Configuration Lease

(71) Applicant: Visa International Service Association, San Francisco, CA (US)

(72) Inventors: Christopher Aaron Coale, Stockton, CA (US); Amit Saini, Pleasanton, CA (US); Sanjeev Kasarabada, Dublin, CA (US)

(21) Appl. No.: 18/840,527

(22) PCT Filed: Feb. 24, 2022
(86) PCT No.: PCT/US2022/017597

§ 371 Date: Aug. 22, 2024

(51) Int. Cl. G06F 9/445; G06F 9/54

(52) U.S. Cl. CPC G06F 9/44505; G06F 9/543

(57) ABSTRACT

Provided is a computer-implemented method, system, and computer program product for leasing decoupled configurations and managing configuration lease persistence with application state management including receiving a configuration set lease request from a client application in response to the client application being launched. In response to receiving the configuration set lease request, the method, system, and computer program product includes determining a unique configuration set from a pool of different configuration sets. Further, the method, system, and computer program product includes communicating the unique configuration set to the client application and activating a lease of the unique configuration set by associating the client application with the unique configuration set in a lease database. In response to determining that the lease is valid, persisting the lease in the lease database. In response to determining that the lease is invalid, deactivating the lease of the unique configuration set in the lease database.

### CROSS-REFERENCE TO RELATED APPLICATION

This application is the United States national phase of International Patent Application No. PCT/US22/17597 filed Feb. 24, 2022, the disclosure of which is hereby incorporated by reference in its entirety.

### BACKGROUND

### 1.Technical Field

The disclosed subject matter relates generally to methods, systems, and products for leasing configurations and, in some non-limiting embodiments or aspects, to a method, system, and computer program product for leasing decoupled configurations and managing configuration lease persistence with application state management.

### 2. Technical Considerations

Software systems and applications generally require specific configuration in order to execute on certain hardware, servers, infrastructure devices, and/or host machines. A configuration may be used to allow an application to operate in conjunction with operating systems and other applications running on a computing device or network of computing devices. Software applications and hardware devices can be increasingly complex, supporting many different configurations and configuration parameters. An operator of a specific software application may be required to specify the configuration parameters that are appropriate for a piece of hardware, server, data center, cloud, or other computing environment. For example, a system may require that each client application connecting to a host machine be assigned a unique and persistent identifier (ID), such that the client application is configured on a per-computing device basis so that the computing device requesting connection to the server will have the same ID from the server's reference point. In this way, a client application may need to be assigned the ID in a static configuration file (e.g., a configuration file that is updated by a user at compile-time of an application) prior to runtime. There are other instances where a client application configuration must be tied to a physical and/or virtual host (e.g., server), such that the configuration is not used by any other host and/or such that the configuration remains constant for an instance of a client application.

When a client application requires a change of configuration, the client application may need to be terminated, the configuration file may need to be edited, and the client application may need to be recompiled and rebuilt in some instances. This process requires manual intervention by a developer to make changes to the configuration. Once the configuration changes are made and the client application is compiled and built, the configuration parameters are locked in and cannot be changed unless the process of editing, compiling, and building is completed again. This process is time consuming, error prone, and requires developers to manually update configuration parameters. Additionally, this process does not lend itself to the use of containerized applications, dynamic deployment of applications, and scaling of applications.

Modern tenants of software engineering include separation of responsibility, reducing dependencies, and decoupling components. By decoupling an application's configuration from the application itself, applications may be free from configuration changes at both compile-time and runtime. In this way, configurations may be assigned dynamically and/or may be decoupled from the physical and/or virtual hosts.

Therefore, there is a need for a method that allows applications to access configuration parameters in a dynamic way which may be scaled to any type of computing environment. Current computer technology possesses a need for runtime configuration loading of containerized applications that would normally require a static server for setting configuration parameters. A system may assign and track the configurations associated with client applications and/or containers running client applications at runtime rather than the client applications or container images having the configurations statically defined at compile-time.

### SUMMARY

Accordingly, provided are improved methods, systems, and computer program products for leasing decoupled configurations and managing configuration lease persistence with application state management.

According to some non-limiting embodiments or aspects, provided is a computer-implemented method for leasing decoupled configurations and managing configuration lease persistence with application state management. The method includes receiving a configuration set lease request from a client application in response to the client application being launched. The method also includes, in response to receiving the configuration set lease request, determining a unique configuration set from a pool of different configuration sets. The method further includes communicating the unique configuration set to the client application. The method further includes activating a lease of the unique configuration set by associating the client application with the unique configuration set in a lease database and removing the unique configuration set from the pool of different configuration sets. The method further includes determining a live status of the client application while the lease is active. The method further includes, in response to determining that the lease is valid based on the live status of the client application, persisting the lease in the lease database. The method further includes, in response to determining that the lease is invalid based on the live status of the client application, deactivating the lease of the unique configuration set in the lease database by adding the unique configuration set back to the pool of different configuration sets.

According to some non-limiting embodiments or aspects, provided is a system for leasing decoupled configurations and managing configuration lease persistence with application state management. The system includes at least one processor programmed and/or configured to receive a configuration set lease request from a client application in response to the client application being launched. The at least one processor is also programmed and/or configured to, in response to receiving the configuration set lease request, determine a unique configuration set from a pool of different configuration sets. The at least one processor is further programmed and/or configured to communicate the unique configuration set to the client application. The at least one processor is further programmed and/or configured to activate a lease of the unique configuration set by associating the client application with the unique configuration set in a lease database and removing the unique configuration set from the pool of different configuration sets. The at least one processor is further programmed and/or configured to determine a live status of the client application while the lease is active. The at least one processor is further programmed and/or configured to, in response to determining that the lease is valid based on the live status of the client, persist the lease in the lease database. The at least one processor is further programmed and/or configured to, in response to determining that the lease is invalid based on the live status of the client, deactivate the lease of the unique configuration set in the lease database by adding the unique configuration set back to the pool of different configuration sets.

According to some non-limiting embodiments or aspects, provided is a computer program product for leasing decoupled configurations and managing configuration lease persistence with application state management. The computer program product includes at least one non-transitory computer-readable medium including one or more instructions that, when executed by at least one processor, cause the at least one processor to receive a configuration set lease request from a client application in response to the client application being launched. The one or more instructions also cause the at least one processor to, in response to receiving the configuration set lease request, determine a unique configuration set from a pool of different configuration sets. The one or more instructions further cause the at least one processor to communicate the unique configuration set to the client application. The one or more instructions further cause the at least one processor to activate a lease of the unique configuration set by associating the client application with the unique configuration set in a lease database and removing the unique configuration set from the pool of different configuration sets. The one or more instructions further cause the at least one processor to determine a live status of the client application while the lease is active. The one or more instructions further cause the at least one processor to, in response to determining that the lease is valid based on the live status of the client, persist the lease in the lease database. The one or more instructions further cause the at least one processor to, in response to determining that the lease is invalid based on the live status of the client, deactivate the lease of the unique configuration set in the lease database by adding the unique configuration set back to the pool of different configuration sets.

Further non-limiting embodiments or aspects are set forth in the following numbered clauses:

Clause 1: A computer-implemented method, comprising: receiving, with at least one processor, a configuration set lease request from a client application in response to the client application being launched; in response to receiving the configuration set lease request, determining, with the at least one processor, a unique configuration set from a pool of different configuration sets; communicating, with the at least one processor, the unique configuration set to the client application; activating, with the at least one processor, a lease of the unique configuration set by associating the client application with the unique configuration set in a lease database and removing the unique configuration set from the pool of different configuration sets; determining, with the at least one processor, a live status of the client application while the lease is active; in response to determining that the lease is valid based on the live status of the client application, persisting, with the at least one processor, the lease in the lease database; and in response to determining that the lease is invalid based on the live status of the client application, deactivating, with the at least one processor, the lease of the unique configuration set in the lease database by adding the unique configuration set back to the pool of different configuration sets.

Clause 2: The computer-implemented method of clause 1, the method further comprising: receiving a lease termination request from the client application in response to an indication that the client application is finished using the unique configuration set; and in response to receiving the lease termination request, deactivating the lease of the unique configuration set in the lease database by adding the unique configuration set back to the pool of different configuration sets.

Clause 3: The computer-implemented method of clauses 1 or 2, wherein the configuration set lease request and the lease termination request are Representational State Transfer (RESTful) Application Programming Interface (API) requests.

Clause 4: The computer-implemented method of any of clauses 1-3, wherein the lease database is at least one of the following: a NoSQL database, an in-memory database, a filesystem store, or any combination thereof.

Clause 5: The computer-implemented method of any of clauses 1-4, wherein the unique configuration set comprises data configured for a computing environment of the client application.

Clause 6: The computer-implemented method of any of clauses 1-5, wherein persisting the lease in the lease database comprises: storing a unique instance identifier (ID) wherein the unique instance ID is associated with the unique configuration set and an instance of the client application; and storing a configuration set ID, wherein the configuration set ID is associated with the instance of the client application; wherein the unique instance ID is associated with the instance of the client application and cannot be associated with any other instances of the client application or with any other client applications.

Clause 7: The computer-implemented method of any of clauses 1-6, wherein deactivating the lease of the unique configuration set in the lease database comprises: adding the unique configuration set back to the pool of different configuration sets; and updating the lease database by removing the association between the unique configuration set and the client application, such that the unique configuration set is not associated with any client applications.

Clause 8: A system, comprising: at least one processor programmed or configured to: receive a configuration set lease request from a client application in response to the client application being launched; in response to receiving the configuration set lease request, determine a unique configuration set from a pool of different configuration sets; communicate the unique configuration set to the client application; activate a lease of the unique configuration set by associating the client application with the unique configuration set in a lease database and removing the unique configuration set from the pool of different configuration sets; determine a live status of the client application while the lease is active; in response to determining that the lease is valid based on the live status of the client, persist the lease in the lease database; and in response to determining that the lease is invalid based on the live status of the client, deactivate the lease of the unique configuration set in the lease database by adding the unique configuration set back to the pool of different configuration sets.

Clause 9: The system of clause 8, wherein the at least one processor is further programmed or configured to: receive a lease termination request from the client application in response to an indication that the client application is finished using the unique configuration set; and in response to receiving the lease termination request, deactivate the lease of the unique configuration set in the lease database by adding the unique configuration set back to the pool of different configuration sets.

Clause 10: The system of clauses 8 or 9, wherein the configuration set lease request and the lease termination request are Representational State Transfer (RESTful) Application Programming Interface (API) requests.

Clause 11: The system of any of clauses 8-10, wherein the lease database is at least one of the following: a NoSQL database, an in-memory database, a filesystem store, or any combination thereof.

Clause 12: The system of any of clauses 8-11, wherein the unique configuration set comprises data relating to a computing environment of the client application.

Clause 13: The system of any of clauses 8-12, wherein, when persisting the lease in the lease database, the at least one processor is programmed or configured to: store a unique instance identifier (ID) wherein the unique instance ID is associated with the unique configuration set and an instance of the client application; and store a configuration set ID, wherein the configuration set ID is associated with the instance of the client application; wherein the unique instance ID is associated with the instance of the client application and cannot be associated with any other instances of the client application or with any other client applications.

Clause 14: The system of any of clauses 8-13, wherein, when deactivating the lease of the unique configuration set in the lease database, the at least one processor is programmed or configured to: add the unique configuration set back to the pool of different configuration sets; and update the lease database by removing the association between the unique configuration set and the client application, such that the unique configuration set is not associated with any client applications.

Clause 15: A computer program product, the computer program product comprising at least one non-transitory computer readable medium including one or more instructions that, when executed by at least one processor, cause the at least one processor to: receive a configuration set lease request from a client application in response to the client application being launched; in response to receiving the configuration set lease request, determine a unique configuration set from a pool of different configuration sets; communicate the unique configuration set to the client application; activate a lease of the unique configuration set by associating the client application with the unique configuration set in a lease database and removing the unique configuration set from the pool of different configuration sets; determine a live status of the client application while the lease is active; in response to determining that the lease is valid based on the live status of the client, persist the lease in the lease database; and in response to determining that the lease is invalid based on the live status of the client, deactivate the lease of the unique configuration set in the lease database by adding the unique configuration set back to the pool of different configuration sets.

Clause 16: The computer program product of clause 15, wherein the one or more instructions further cause the at least one processor to: receive a lease termination request from the client application in response to an indication that the client application is finished using the unique configuration set; and in response to receiving the lease termination request, deactivate the lease of the unique configuration set in the lease database by adding the unique configuration set back to the pool of different configuration sets.

Clause 17: The computer program product of clauses 15 or 16, wherein the lease database is at least one of the following: a NoSQL database, an in-memory database, a filesystem store, or any combination thereof.

Clause 18: The computer program product of any of clauses 15-17, wherein the unique configuration set comprises data relating to a computing environment of the client application.

Clause 19: The computer program product of any of clauses 15-18, wherein the one or more instructions that cause the at least one processor to persist the lease in the lease database cause the at least one processor to: store a unique instance identifier (ID) wherein the unique instance ID is associated with the unique configuration set and an instance of the client application; and store a configuration set ID, wherein the configuration set ID is associated with the instance of the client application; wherein the unique instance ID is associated with the instance of the client application and cannot be associated with any other instances of the client application or with any other client applications.

Clause 20: The computer program product of any of clauses 15-19, wherein the one or more instructions that cause the at least one processor to deactivate the lease of the unique configuration set in the lease database cause the at least one processor to: add the unique configuration set back to the pool of different configuration sets; and update the lease database by removing the association between the unique configuration set and the client application, such that the unique configuration set is not associated with any client applications.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a schematic diagram of a system for leasing decoupled configurations and managing configuration lease persistence with application state management according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for leasing decoupled configurations and managing configuration lease persistence with application state management according to the principles of the presently disclosed subject matter;

FIG. 4 is a schematic diagram of a system for leasing decoupled configurations and managing configuration lease persistence with application state management according to an exemplary embodiment or aspect; and

FIGS. 5A-5C are diagrams of non-limiting embodiments or aspects of an implementation of a process for leasing decoupled configurations and managing configuration lease persistence with application state management according to some non-limiting embodiments or aspects.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to one or more computing devices (e.g., processors, storage devices, similar computer components, and/or the like) that communicate with client devices and/or other computing devices over a network (e.g., a public network, the Internet, a private network, and/or the like) and, in some examples, facilitate communication among other servers and/or client devices. It will be appreciated that various other arrangements are possible. Further, multiple computing devices (e.g., servers, point-of-sale (POS) devices, mobile devices, etc.) directly or indirectly communicating in the network environment may constitute a “system.”

As used herein, the term “client” may refer to one or more computing devices (e.g., processors, storage devices, containers, virtual machines, similar computer components, and/or the like) that communicate with server devices and/or other computing devices over a network (e.g., a public network, the Internet, a private network, and/or the like). In some examples, a “client” may refer to a computing device which may execute an application, connect with a server, and/or access a server over a network.

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

Provided are systems, methods, and computer program products for leasing decoupled configurations and applying state management techniques. Non-limiting embodiments or aspects of the disclosed subject matter are directed to systems, methods, and computer program products for leasing decoupled configurations, including but not limited to, software application configurations, and managing configuration persistence with state management. Embodiments of the present disclosure may include a system for leasing configurations with state management to prevent an application configuration from being coupled to a physical and/or virtual host and to allow for the implementation of containerized applications, dynamic application deployment, and application scaling.

Non-limiting embodiments or aspects of the present disclosure decouple a configuration and/or configuration file from a physical and/or virtual host or executing application, such that the configuration does not have to be manually updated or changed at compile-time. The configuration leasing system may allow for the isolation of a codebase from any host and configuration dependencies, thereby requiring less developer intervention when applications may need to have configurations dynamically changed or when applications may need to be scaled. Non-limiting embodiments or aspects of the configuration leasing system may allow for dynamic and auto-scaling of containerized applications by using configurations which are decoupled from application servers and configurations which are decoupled from an application both at compile-time and runtime. Embodiments or aspects of the configuration lease system may allow for applications that otherwise would be restricted from scaling to lease a configuration at runtime and maintain uniqueness and constancy of the configuration such that the application may be scaled without developer intervention and manual changes to application configuration. In some non-limiting embodiments or aspects, the configuration lease system may allow for the ability to move applications from physical and/or virtual hosts to logical containers without making manual configuration changes. In some non-limiting embodiments or aspects, the configuration lease system may allow for simplified deployment of applications among multiple hosts in situations where hosts are removed or taken out of service for maintenance. In this way, the configuration lease system allows for the dynamic switching of physical and/or virtual hosts and client applications without having to manually change the configuration of applications.

For the purpose of illustration, in the following description, while the presently disclosed subject matter is described with respect to methods, systems, and computer program products for leasing decoupled configurations and managing configuration persistence, one skilled in the art will recognize that the disclosed subject matter is not limited to the illustrative embodiments or aspects. For example, the methods, systems, and computer program products described herein may be used with a wide variety of settings, such as software systems and/or integrated software-hardware systems in any setting suitable for using such leasing of decoupled configurations and managing configuration persistence.

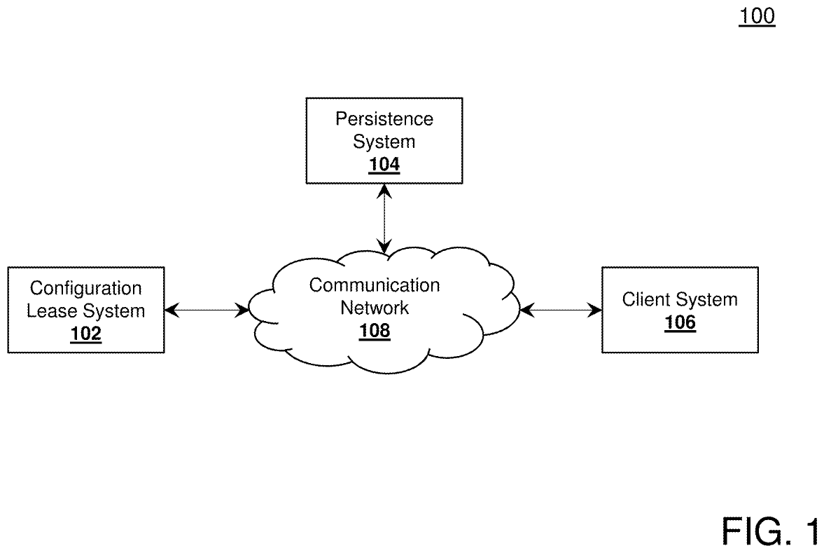

Referring now to FIG. 1, FIG. 1 is a diagram of a system 100 for leasing decoupled configurations and managing configuration lease persistence with application state management according to some non-limiting embodiments or aspects. As shown in FIG. 1, the system 100 may include configuration lease system 102, persistence system 104, and client system 106. Configuration lease system 102, persistence system 104, and client system 106 may be in communication via communication network 108 and/or one or more other networks, such as, but not limited to, private networks and/or public networks (e.g., such as the Internet).

In some non-limiting embodiments or aspects, configuration lease system 102 may include one or more hosts (e.g., servers, application servers, and/or the like). In some non-limiting embodiments or aspects, configuration lease system 102 may include a pool of configuration sets. In some non-limiting embodiments or aspects, a pool may include a collection of resources that are ready for use by clients and/or systems. In some non-limiting embodiments or aspects, a resource in a pool may be removed from the pool when in use and may be placed back into the pool when not in use. In some non-limiting embodiments or aspects, a pool of configuration sets may include one or more configuration sets available for use by client system 106 and/or client applications.

In some non-limiting embodiments or aspects, a configuration set may include a file (e.g., configuration file) or other computing resource (e.g., data structures stored in a storage component and/or memory, etc.) used to set parameters and/or initialize settings for an application. In some non-limiting embodiments or aspects, a configuration set may include a plurality of parameters which can be set to at least one value, such as file paths, execution environments, identifiers for computing devices, version numbers of applications, and/or the like.

In some non-limiting embodiments or aspects, configuration lease system 102 may contain persistence system 104. In some non-limiting embodiments or aspects, persistence system 104 may include a computing device and a data storage device including a database (e.g., on-disk database, in-memory database, NoSQL database, filesystem store, and/or the like). Persistence system 104 may include any suitable computing device and/or system for storing and persisting data. In some non-limiting embodiments or aspects, persistence system 104 may be capable of persisting data without data loss in the event configuration lease system 102, and/or any other components of the system 100, shutdown unexpectedly.

In some non-limiting embodiments or aspects, client system 106 may include a computing device executing client applications. In some non-limiting embodiments or aspects, system 100 may include one or more client systems 106 in communication with configuration lease system 102 and/or persistence system 104. In some non-limiting embodiments or aspects, client system 106 may be in communication with one or more client applications. In some non-limiting embodiments or aspects, one or more client applications may execute on client system 106. In some non-limiting embodiments or aspects, client system 106 may include a hardware computing device executing software and/or client applications. In some non-limiting embodiments or aspects, client system 106 may include a software component (e.g., operating system, virtual machine, computing environment, and/or the like) executing one or more client applications on a computing device.

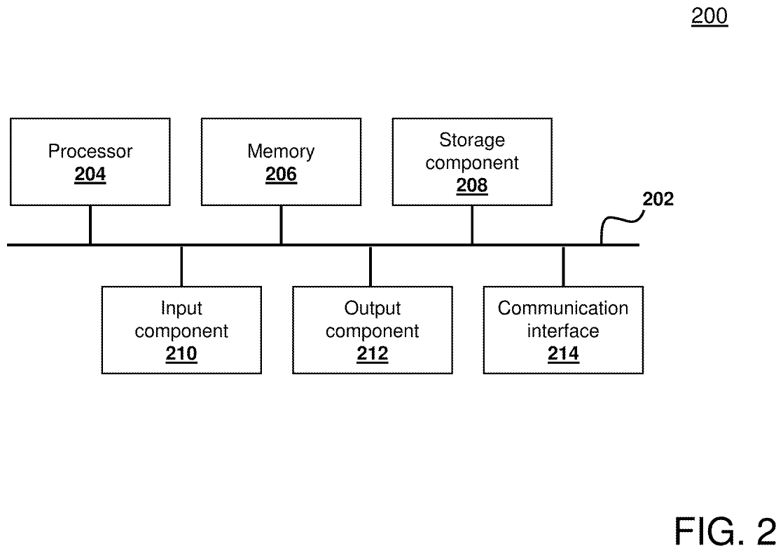

Referring now to FIG. 2, FIG. 2 is a diagram of example components of a device 200. Device 200 may correspond to one or more devices of configuration lease system 102, one or more devices of persistence system 104, and/or one or more devices of client system 106. In some non-limiting embodiments or aspects, configuration lease system 102, persistence system 104, and/or client system 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like), and/or the like, which can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a receiver and transmitter that are separate, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like. In some non-limiting embodiments or aspects, communication interface 214 may communicate with other devices via communication network 108.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database and/or the like). Device 200 may be capable of receiving information from, storing information in, communicating information to, or searching information stored in the data storage or one or more data structures in memory 206 and/or storage component 208. For example, the information may include input data, output data, transaction data, account data, or any combination thereof. In some non-limiting embodiments or aspects, persistence system 104 may be the same as or similar to memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

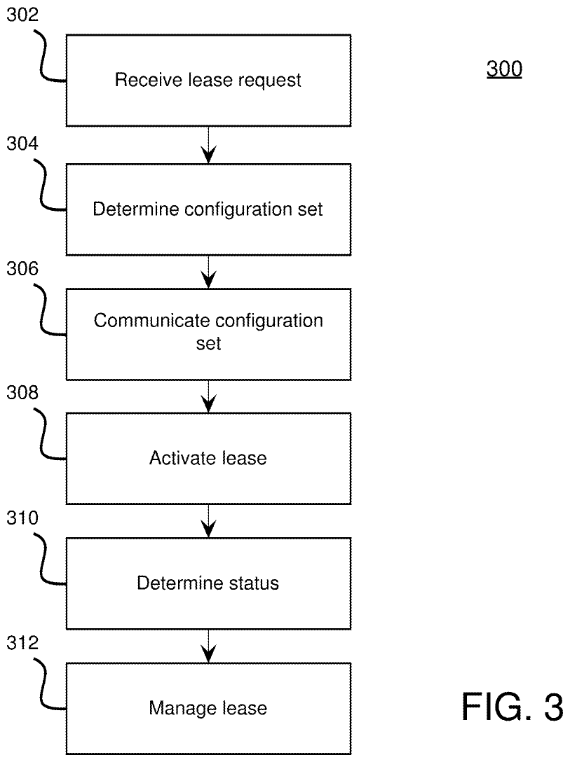

Referring now to FIG. 3, FIG. 3 is a flowchart of a non-limiting embodiment or aspect of a process 300 for leasing decoupled configurations and managing configuration lease persistence with state management and live status checks according to non-limiting embodiments or aspects. In some non-limiting embodiments or aspects, one or more of the functions described with respect to process 300 may be performed (e.g., completely, partially, etc.) by configuration lease system 102. In some non-limiting embodiments or aspects, one or more of the steps of process 300 may be performed (e.g., completely, partially, and/or the like) by another device or a group of devices separate from or including configuration lease system 102, such as persistence system 104 and/or client system 106. It will be appreciated that, in non-limiting embodiments, additional, different, fewer, and/or a different order of steps may be used than the example shown in FIG. 3.

As shown in FIG. 3, at step 302, process 300 may include receiving a lease request (e.g., a structured message between computing devices). In some non-limiting embodiments or aspects, configuration lease system 102 may receive a configuration set lease request from a client application in response to the client application being launched. For example, configuration lease system 102 may receive a configuration set lease request from a client application instance after the client application is launched and begins execution on a client machine (e.g., in response to executing the client application), such as client system 106. In some non-limiting embodiments or aspects, configuration lease system 102 may receive a lease request in real-time (e.g., instantaneously, near-instantaneously, or in a guaranteed time within a specified deadline, such as within a matter of milliseconds or seconds) with respect to the launching of the client application. In some non-limiting embodiments or aspects, configuration lease system 102 may receive a lease request asynchronously with respect to the launching of the client application. For example, configuration lease system 102 may receive a lease request within a period of time (e.g., minutes, hours, and/or days) after the launching of the client application. In this way, the client application may be on hold (e.g., the client application may launch and initialize, and wait in the initialization state until a lease request is received by configuration lease system 102 and a response to the lease request is received by the client application, at which time the client application may enter the execution state in response to receiving the response from configuration lease system 102) from requesting a lease and may not be able to execute until a lease request is sent to configuration lease system 102 and received and processed by configuration lease system 102. In some non-limiting embodiments or aspects, configuration lease system 102 may receive a lease request from client system 106. In some non-limiting embodiments or aspects, client system 106 may be executing the client application. In some non-limiting embodiments or aspects, client system 106 may include the client application.

In some non-limiting embodiments or aspects, configuration lease system 102 may receive a configuration set lease request which requests the temporary use of a configuration set by a client application. In some non-limiting embodiments or aspects, a configuration set lease request may include a Representational State Transfer (RESTful) Application Program Interface (API) request. In some non-limiting embodiments or aspects, configuration lease system 102 may receive a configuration set lease request containing data corresponding to the client application. For example, configuration lease system 102 may receive a configuration set lease request containing data about the client application such as its computing environment (e.g., test, production, etc.) and data about client system 106. This data may be used by configuration lease system 102 to determine the configuration set to return to the client application. In some non-limiting embodiments or aspects, the unique configuration set may include data relating to the computing environment of the client application and/or client system 106.

As shown in FIG. 3, at step 304, process 300 may include determining a configuration set. In some non-limiting embodiments or aspects, configuration lease system 102 may determine a unique configuration set from a pool of different configuration sets in response to receiving the configuration set lease request. In some non-limiting embodiments or aspects, configuration lease system 102 may determine a configuration set based on data corresponding to client system 106 and/or the client application contained in the configuration set lease request that was received from client system 106 and/or the client application. In some non-limiting embodiments or aspects, configuration lease system 102 may determine a configuration set by selecting a configuration set from the pool of different configuration sets that corresponds to the information about client system 106 and/or the client application, such as information about client system 106 and/or the client application relating to a classification of an execution environment. For example, configuration lease system 102 may select a configuration set containing an execution environment corresponding to a classification (e.g., label) of “production” based on the execution environment of the client application identified in the configuration set lease request. In some non-limiting embodiments or aspects, configuration lease system 102 may determine a configuration set based on parameters of client system 106 that are not identified in the configuration set lease request. For example, configuration lease system 102 may be capable of determining the execution environment, location, and/or other parameters of client system 106 independent of the data in the configuration set lease request. In this way, configuration lease system 102 may select the configuration set based on those parameters of client system 106.

In some non-limiting embodiments or aspects, configuration lease system 102 may determine a unique configuration set from a pool of different configuration sets by selecting a unique configuration set from the pool of different configuration sets. In some non-limiting embodiments or aspects, a unique configuration has a unique instance identifier (ID). In some non-limiting embodiments or aspects, an ID may include a string, an integer, a character, a hash, and/or the like. In this way, each configuration set in the pool of different configuration sets has a unique instance ID.

In some non-limiting embodiments or aspects, configuration lease system 102 may determine a configuration set in response to receiving the configuration set lease request. In some non-limiting embodiments or aspects, configuration lease system 102 may determine a configuration set in real-time with respect to receiving the configuration set lease request. In some non-limiting embodiments or aspects, configuration lease system 102 may determine a configuration set asynchronously with respect to receiving the configuration set lease request. For example, configuration lease system 102 may determine a configuration set within a period of time (e.g., minutes, hours, and/or days) after receiving the configuration set lease request.

As shown in FIG. 3, at step 306, process 300 may include communicating a configuration set. In some non-limiting embodiments or aspects, configuration lease system 102 may communicate a unique configuration set to the client application. In some non-limiting embodiments or aspects, configuration lease system 102 may communicate the unique configuration set to client system 106. In some non-limiting embodiments or aspects, configuration lease system 102 may communicate the unique configuration set via communication network 108. In some non-limiting embodiments or aspects, configuration lease system 102 may be executing on the same computing device as client system 106. Thus, in that instance, configuration lease system 102 may communicate the unique configuration set via intra-device communications.

As shown in FIG. 3, at step 308, process 300 may include activating a lease. In some non-limiting embodiments or aspects, configuration lease system 102 may activate a lease of the unique configuration set by associating the client application with the unique configuration set in a lease database and removing the unique configuration set from the pool of different configuration sets. In some non-limiting embodiments or aspects, configuration lease system 102 may associate the client application with the unique configuration set in a lease database by associating a unique instance ID corresponding to the unique configuration set with an instance of the client application. For example, configuration lease system 102 may associate an ID of the instance of the client application with the instance ID corresponding to the unique configuration set by storing the unique instance ID, a unique configuration set ID, and a client application ID in an entry of the lease database where the unique instance ID represents the key. In some non-limiting embodiments or aspects, configuration lease system 102 may activate a lease by limiting access to the unique configuration set (e.g., placing a lock on the unique configuration set by setting a flag or the like), such that the unique configuration set can only be accessed by the associated client application. In some non-limiting embodiments or aspects, the lease database may be the same as or similar to persistence system 104.

As shown in FIG. 3, at step 310, process 300 may include determining a status. In some non-limiting embodiments or aspects, configuration lease system 102 may determine a live status of the client application while the lease is active. In some non-limiting embodiments or aspects, configuration lease system 102 may determine the live status of the client application by polling the client application and/or client system 106 executing client applications which have an active lease on one or more configuration sets. In some non-limiting embodiments or aspects, configuration lease system 102 may poll client system 106 by sending a request to client system 106 to return an execution status of executing client applications which are associated with active leases. For example, configuration lease system 102 may send a request to client system 106. Client system 106 may return a response containing an indication that the client application is “live” and executing (e.g., in runtime) or that the client application is “not live” and not executing (e.g., shutdown, failed, returned a runtime exception, etc.). In some-non-limiting embodiments or aspects, configuration lease system 102 may determine that the active lease is valid based on determining that the client application is “live” and executing. In some-non-limiting embodiments or aspects, configuration lease system 102 may determine that the active lease is invalid based on determining that the client application is “not live” and not executing and/or that an error has occurred with the client application. In some non-limiting embodiments or aspects, configuration lease system 102 may determine which client applications are associated with an active lease by retrieving entries containing a unique instance ID in the lease database.

As shown in FIG. 3, at step 312, process 300 may include managing a lease. In some non-limiting embodiments or aspects, configuration lease system 102 may manage the lease of the unique configuration of one or more client applications by persisting the lease in the lease database. In some non-limiting embodiments or aspects, configuration lease system 102 may persist the lease in the lease database in response to determining that the lease is valid based on the live status of the client application. For example, configuration lease system 102 may determine that the lease of the unique configuration of the client application is valid based on a response of “live” from the client application and/or client system 106. Once the lease is determined to be valid, configuration lease system 102 may persist the lease in the lease database by performing validation checks on the data in the lease database (e.g., persistence system 104) to ensure the lease remains active for the particular client application that had its live status polled.

In some non-limiting embodiments or aspects, persisting the lease in the lease database may include any suitable validation checks or runtime monitoring of the client application, client system 106, and/or the lease database (e.g., persistence system 104) and the data stored in the lease database. In some non-limiting embodiments or aspects, persisting the lease in the lease database may include storing a unique instance ID in association with the unique configuration set and an instance of the client application in the lease database (e.g., persistence system 104). In some non-limiting embodiments or aspects, persisting the lease in the lease database may include storing a configuration set ID in association with the instance of the client application in the lease database (e.g., persistence system 104). In some non-limiting embodiments or aspects, the unique instance ID may be associated with the instance of the client application and may not be capable of being associated with any other instances of the client application, with any other client applications, and/or with any other client system 106.

In some non-limiting embodiments or aspects, configuration lease system 102 may manage the lease of the unique configuration of one or more client applications by deactivating the lease of the unique configuration set in the lease database. In some non-limiting embodiments or aspects, configuration lease system 102 may deactivate the lease of the unique configuration set by adding the unique configuration set back to the pool of different configuration sets. In some non-limiting embodiments or aspects, configuration lease system 102 may deactivate the lease of the unique configuration set in the lease database in response to determining that the lease is invalid based on the live status of the client application. For example, configuration lease system 102 may determine that the lease of the unique configuration of the client application is invalid based on a response of “not live” from the client application and/or client system 106. Once the lease is determined to be invalid, configuration lease system 102 may deactivate the lease in the lease database by removing the instance ID corresponding to the client application from the entry in the lease database (e.g., persistence system 104). This action of deactivation has the effect of removing the lease and the unique configuration set from the client application and adding the unique configuration set back to the pool of different configuration sets so that the unique configuration set is available to be leased to another client application.

In some non-limiting embodiments or aspects, deactivating the lease in the lease database may include any suitable method for destroying the association between the lease of the unique configuration set and the client application (e.g., deleting the entry in the lease database, deleting a file containing the association, removing the configuration set object and placing it back in the pool of configuration sets, etc.). For example, deactivating the lease of the unique configuration set in the lease database may include updating the lease database by removing the association between the unique configuration set and the client application and/or client system 106, such that the unique configuration set is not associated with any client applications or any client system 106. In this way, the association between the unique configuration set and the client application and/or client system 106 is not persisted in the lease database (e.g., persistence system 104), whether or not the unique configuration set is added back to the pool of different configuration sets in real-time with respect to removing the association in the lease database, at a later time, or not at all.

In some non-limiting embodiments or aspects, configuration lease system 102 may manage a lease by receiving a termination request from the client application and/or client system 106. In some non-limiting embodiments or aspects, configuration lease system 102 may receive a lease termination request from the client application in response to an indication that the client application is finished using the unique configuration set. For example, the client application may indicate that it is finished using the unique configuration set by receiving a request to gracefully shutdown and/or reaching the end of an execution sequence (e.g., any graceful termination indication that does not indicate an error, failure, handled exception, unhandled exception, etc.). In response to any one of the possible indications that the client is finished using the unique configuration set, the client application and/or client system 106 may send, and configuration lease system 102 may receive a lease termination request from the client application and/or client system 106. In some non-limiting embodiments or aspects, the lease termination request may include a RESTful API request. In some non-limiting embodiments or aspects, configuration lease system 102 may deactivate the lease of the unique configuration set in the lease database in response to receiving the lease termination request. Configuration lease system 102 may deactivate the lease of the unique configuration set in the lease database by adding the unique configuration set back to the pool of different configuration sets, or by any of the methods for deactivating a lease described herein.

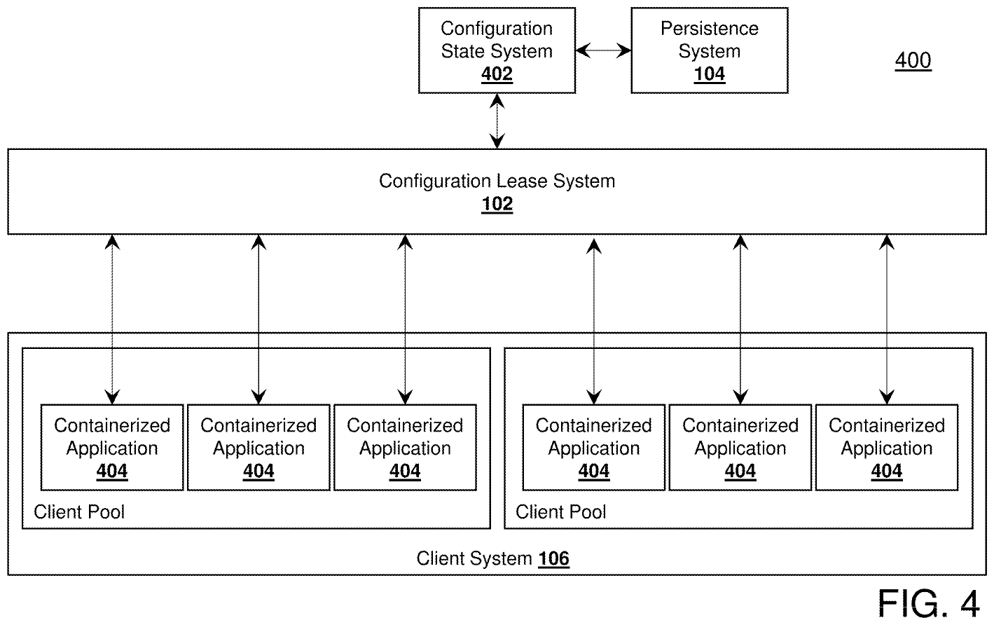

Referring now to FIG. 4, FIG. 4 is a schematic diagram of a system 400 for leasing decoupled configurations and managing configuration lease persistence with application state management according to an exemplary embodiment or aspect. As shown in FIG. 4, system 400 may include configuration lease system 102, persistence system 104, client system 106, configuration state system 402, and containerized applications 404.

In some non-limiting embodiments or aspects, configuration lease system 102 may include one or more hosts (e.g., servers, application servers, and/or the like). In some non-limiting embodiments or aspects, configuration lease system 102 may be in communication with configuration state system 402 and/or persistence system 104. In some non-limiting embodiments or aspects, configuration lease system 102 may be in communication with one or more containerized application 404 and/or client system 106. In some non-limiting embodiments or aspects, configuration lease system 102 may include persistence system 104 and/or configuration state system 402.

In some non-limiting embodiments or aspects, persistence system 104 may include a computing device and a data storage device including a database (e.g., on-disk database, in-memory database, NoSQL database, filesystem store, and/or the like). Persistence system 104 may include any suitable computing device and/or system for storing and persisting data. In some non-limiting embodiments or aspects, persistence system 104 may include a lease database. In some non-limiting embodiments or aspects, persistence system 104 may communicate with configuration lease system 102 and/or configuration state system 402. In some non-limiting embodiments or aspects, persistence system 104 may be capable of persisting data without data loss in the event configuration lease system 102, and/or any other components of system 400, shutdown unexpectedly.

In some non-limiting embodiments or aspects, client system 106 may include a computing device executing client applications and/or containerized applications 404. In some non-limiting embodiments or aspects, client system 106 may be in communication with configuration lease system 102, and/or one or more containerized application 404. In some non-limiting embodiments or aspects, one or more containerized application 404 may execute on client system 106. In some non-limiting embodiments or aspects, client system 106 may include a hardware computing device executing software and/or one or more containerized application 404. In some non-limiting embodiments or aspects, client system 106 may include a software component (e.g., operating system, virtual machine, computing environment, and/or the like) executing one or more containerized application 404 on a computing device.

In some non-limiting embodiments or aspects, configuration state system 402 may include a NoSQL database. For example, configuration state system 402 may include an in-memory key-value store (e.g., Hazelcast® NoSQL cache, and/or the like). In some non-limiting embodiments or aspects, configuration state system 402 may operate in conjunction with persistence system 104 to store, retrieve, and query data in persistence system 104 and/or share data with configuration lease system 102. In some non-limiting embodiments or aspects, configuration state system 402 may manage states of leases and/or configuration sets in the pool of different configuration sets. In some non-limiting embodiments or aspects, configuration state system 402 may include persistence system 104. In some non-limiting embodiments or aspects, configuration state system 402 may be in communication with configuration lease system 102 and/or persistence system 104.

In some non-limiting embodiments or aspects, system 400 may include one or more containerized application 404. In some non-limiting embodiments or aspects, containerized application 404 may include a client application executing in a logical container. In some non-limiting embodiments or aspects, containerized application 404 may execute on client system 106. Additionally or alternatively, one or more containerized application 404 may execute in separate client pools. In some non-limiting embodiments or aspects, containerized application 404 may execute within a virtual machine. In some non-limiting embodiments or aspects, containerized application 404 may be in communication with configuration lease system 102 and/or client system 106.

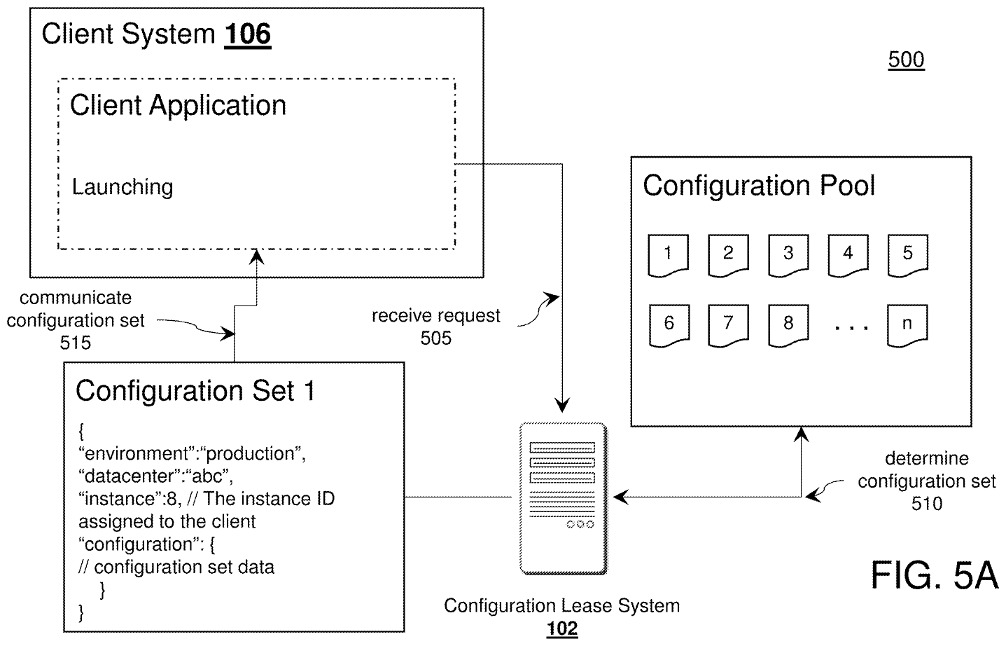

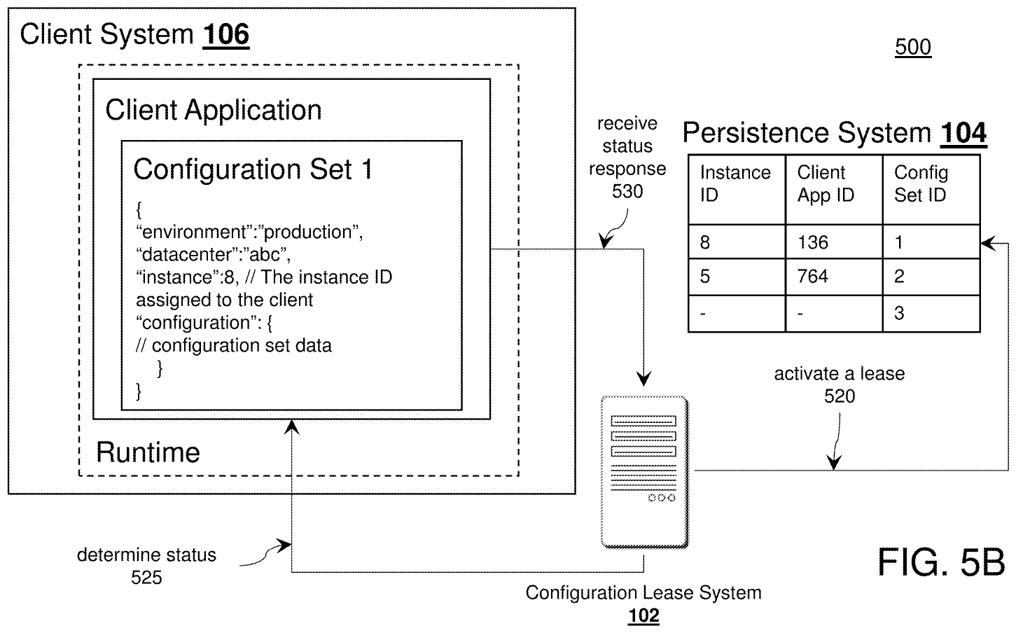

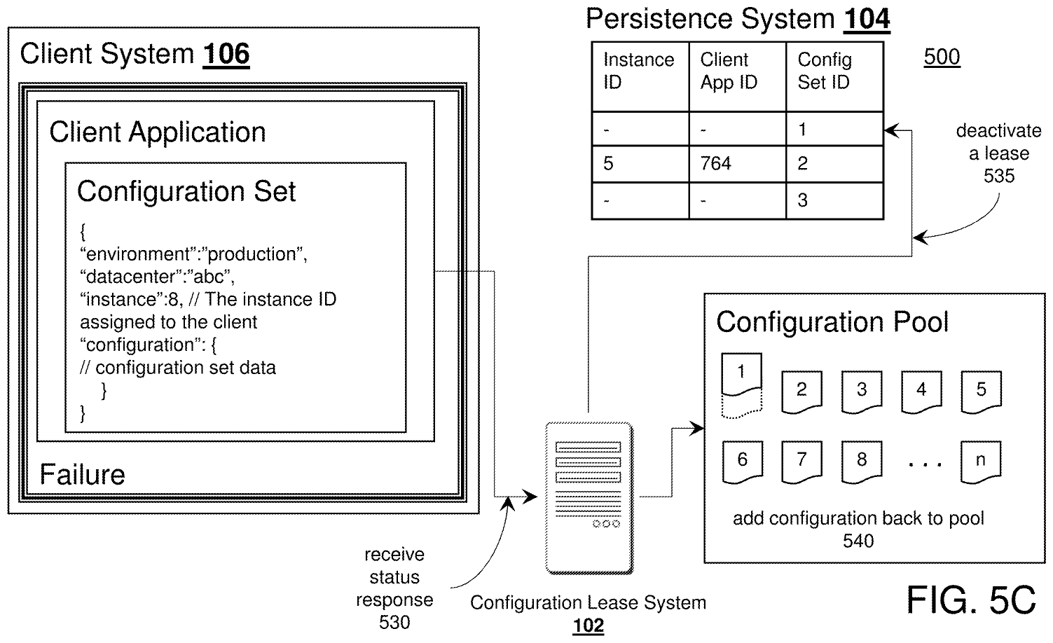

Referring now to FIGS. 5A-5C, FIGS. 5A-5C are diagrams of non-limiting embodiments or aspects of an implementation 500 of a process (e.g., process 300) for leasing decoupled configurations and managing configuration lease persistence with application state management according to some non-limiting embodiments or aspects.

As shown in FIG. 5A, configuration lease system 102 may receive a request 505 from a client application in response to the client application being launched. In some non-limiting embodiments or aspects, configuration lease system may receive a request for a configuration set lease (e.g., a configuration set lease request). In some non-limiting embodiments or aspects, the client application may be launched on client system 106. The client application may send the request, via communication between client system 106 and configuration lease system 102, to configuration lease system 102. The request may be in any suitable format, such as an API request (e.g., RESTful API request) and/or the like. In some non-limiting embodiments or aspects, the client application may complete launching and transition to execution in response to receiving a response (e.g., communicating a configuration set 515) from configuration lease system 102 activating a configuration set lease. In some non-limiting embodiments or aspects, the client application may not complete launching and transition to execution until the client application receives a response (e.g., communicating a configuration set 515) from configuration lease system 102 activating a configuration set lease. In some non-limiting embodiments or aspects, configuration lease system 102 may return a response indicating that the client application may send another request (e.g., subsequent request, additional requests, etc.) to configuration lease system 102 based on configuration lease system 102 returning an error based on the received request (e.g., the request contains data in an unknown format, incorrect formatting of the request, etc.).

In some non-limiting embodiments or aspects, configuration lease system 102 may determine a configuration set 510. In some non-limiting embodiments or aspects, configuration lease system 102 may determine a unique configuration set. In some non-limiting embodiments or aspects, configuration lease system 102 may determine a unique configuration set from a pool of different configuration sets (e.g., configuration pool) in response to receiving the request (e.g., configuration set lease request). For example, configuration lease system 102 may determine a unique configuration set from a pool of different configuration sets by selecting a configuration set from the pool of different configuration sets based on the data received in the request. In some non-limiting embodiments or aspects, configuration lease system 102 may parse the pool of different configuration sets until a configuration set with a specific requirement is found. Additionally or alternatively, configuration lease system 102 may select the first available configuration set from the pool of different configuration sets that satisfies any requirements based on the client application.

In some non-limiting embodiments or aspects, the pool of different configuration sets may contain any amount of unique configuration sets. In some non-limiting embodiments or aspects, each configuration set of the pool of different configuration sets may be predetermined. In some non-limiting embodiments or aspects, each configuration set of the pool of different configuration sets may be determined by configuration lease system 102 in real-time based on the client application and/or client system 106. For example, a configuration set containing data related to a specific datacenter “abc” may not preexist in the pool of different configuration sets, and/or the data center or client system 106 may be unknown to configuration lease system 102. In this way, configuration lease system 102 may populate data in real-time based on the client application and/or client system 106 in response to receiving the request 505 to determine the unique configuration set.

In some non-limiting embodiments or aspects, configuration lease system 102 may communicate the configuration set 515 to the client application. In some non-limiting embodiments or aspects, configuration lease system 102 may communicate a unique configuration set to the client application. In some non-limiting embodiments or aspects, configuration lease system 102 may apply the unique configuration set to the client application dynamically (e.g., while the client application is launched). In some non-limiting embodiments or aspects, the client application may be containerized in a container image (e.g., Docker® container image, Kubernetes® container image, etc.). In some non-limiting embodiments or aspects, configuration lease system 102 may communicate the unique configuration set to the containerized application 404 image to apply the unique configuration dynamically (e.g., while the container is running).

As shown in FIG. 5B, configuration lease system 102 may activate a lease 520 of the unique configuration set. In some non-limiting embodiments or aspects, configuration lease system 102 may activate a lease by associating the client application with the unique configuration set in persistence system 104 and removing the unique configuration set from the pool of different configuration sets. In some non-limiting embodiments or aspects, configuration lease system 102 may activate the lease of the unique configuration set in real-time with respect to the client application beginning execution (e.g., entering a runtime phase). In some non-limiting embodiments or aspects, configuration lease system 102 may activate the lease 520 of the unique configuration set before the client application begins execution. Although FIG. 5B shows persistence system 104 storage in a table format, persistence system 104 storage may be in any suitable format, such that persistence system 104 is capable of associating the unique configuration set with an instance of a client application (e.g., a relational database, key-value database, hierarchical database, graph database, and/or the like).

In some non-limiting embodiments or aspects, configuration lease system 102 may determine a status 525 of the client application while the lease is active. In some non-limiting embodiments or aspects, configuration lease system 102 may determine a live status (e.g., status in real-time) of the client application while the lease is active. In some non-limiting embodiments or aspects, configuration lease system 102 may determine a status 525 of the client application by polling the client application with an active lease on a unique configuration set. In some non-limiting embodiments or aspects, configuration lease system 102 may poll the client application by sending a request to the client application to return an execution status of the client application which is associated with the active lease. In some non-limiting embodiments or aspects, the request may include a RESTful API request. In some non-limiting embodiments or aspects, in response to the request to poll the client application, configuration lease system 102 may receive a status response 530 from the client application indicating the state of the client application. In some non-limiting embodiments or aspects, configuration lease system 102 may receive a live status (e.g., status in real-time) response from the client application indicating the state of the client application. If the client application is in the runtime phase, the client application may return a live status response 530 including an indicator of “runtime” or “live.” This informs configuration lease system 102 that the client application is running and is still using the active lease. If the client application is not in the runtime phase, the client application may return a live status response 530 including an indicator of “not in runtime” or “not live.” In some non-limiting embodiments or aspects, a client application may return a response indicator of “not live” when the client application has stopped executing (e.g., failed, shutdown, returned an unhandled exception, returned a handled exception, failed to launch, etc.).

In some non-limiting embodiments or aspects, configuration lease system 102 may persist the lease in persistence system 104 in response to determining that the lease is valid based on the live status of the client application. In some non-limiting embodiments or aspects, configuration lease system 102 may receive a live status response 530 from the client application indicating that the client application is “live.” When the live status response 530 from the client application indicates that the client application is “live,” configuration lease system 102 may consider that the lease of the unique configuration set to the client application is valid. In some non-limiting embodiments or aspects, configuration lease system 102 may persist the lease in the persistence system 104 by taking no action in response to determining that the lease is valid. In some non-limiting embodiments or aspects, configuration lease system 102 may persist the lease in persistence system 104 by performing validation checks on the data stored in persistence system 104. In some non-limiting embodiments or aspects, configuration lease system 102 may persist the lease in persistence system 104 by logging and/or storing the latest status (e.g., “live” or “not live,” “runtime” or “not in runtime,” etc.) of the client application.

As shown in FIG. 5C, configuration lease system 102 may deactivate a lease 535 of the unique configuration set in persistence system 104 by adding the unique configuration set back to the pool of different configuration sets 540 in response to determining that the lease is invalid based on the live status response 530 of the client application. In some non-limiting embodiments or aspects, configuration lease system 102 may receive a live status response 530 from the client application indicating that the client application is “not live.” When the live status response 530 from the client application indicates that the client application is “not live,” configuration lease system 102 may determine that the lease of the unique configuration set to the client application is invalid. In some non-limiting embodiments or aspects, configuration lease system 102 may receive a live status response 530 from the client application that indicates the client application is “not live” when the client application has experienced a failure. In some non-limiting embodiments or aspects, configuration lease system 102 may deactivate the lease 535 in persistence system 104 by removing the instance ID corresponding to the client application from an entry in persistence system 104. In some non-limiting embodiments or aspects, configuration lease system 102 may deactivate the lease 535 in persistence system 104 by adding the unique configuration set back to the pool of different configuration sets 540. In some non-limiting embodiments or aspects, configuration lease system 102 may deactivate the lease 535 in persistence system 104 by any suitable method which removes the association between the unique configuration set and the instance of the client application stored in persistence system 104.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
receiving, with at least one processor, a configuration set lease request from a client application in response to the client application being launched;
in response to receiving the configuration set lease request, determining, with the at least one processor, a unique configuration set from a pool of different configuration sets;
communicating, with the at least one processor, the unique configuration set to the client application;
activating, with the at least one processor, a lease of the unique configuration set by associating the client application with the unique configuration set in a lease database and removing the unique configuration set from the pool of different configuration sets;
determining, with the at least one processor, a live status of the client application while the lease is active;
in response to determining that the lease is valid based on the live status of the client application, persisting, with the at least one processor, the lease in the lease database; and
in response to determining that the lease is invalid based on the live status of the client application, deactivating, with the at least one processor, the lease of the unique configuration set in the lease database by adding the unique configuration set back to the pool of different configuration sets.

2. The computer-implemented method of claim 1, the method further comprising:
receiving a lease termination request from the client application in response to an indication that the client application is finished using the unique configuration set; and
in response to receiving the lease termination request, deactivating the lease of the unique configuration set in the lease database by adding the unique configuration set back to the pool of different configuration sets.

3. The computer-implemented method of claim 2, wherein the configuration set lease request and the lease termination request are Representational State Transfer (RESTful) Application Programming Interface (API) requests.

4. The computer-implemented method of claim 1, wherein the lease database is at least one of the following: a NoSQL database, an in-memory database, a filesystem store, or any combination thereof.

5. The computer-implemented method of claim 1, wherein the unique configuration set comprises data configured for a computing environment of the client application.

6. The computer-implemented method of claim 1, wherein persisting the lease in the lease database comprises:
storing a unique instance identifier (ID) wherein the unique instance ID is associated with the unique configuration set and an instance of the client application; and
storing a configuration set ID, wherein the configuration set ID is associated with the instance of the client application;
wherein the unique instance ID is associated with the instance of the client application and cannot be associated with any other instances of the client application or with any other client applications.

7. The computer-implemented method of claim 1, wherein deactivating the lease of the unique configuration set in the lease database comprises:
adding the unique configuration set back to the pool of different configuration sets; and
updating the lease database by removing the association between the unique configuration set and the client application, such that the unique configuration set is not associated with any client applications.

8. A system, comprising:
at least one processor programmed or configured to:
receive a configuration set lease request from a client application in response to the client application being launched;
in response to receiving the configuration set lease request, determine a unique configuration set from a pool of different configuration sets;
communicate the unique configuration set to the client application;
activate a lease of the unique configuration set by associating the client application with the unique configuration set in a lease database and removing the unique configuration set from the pool of different configuration sets;
determine a live status of the client application while the lease is active;
in response to determining that the lease is valid based on the live status of the client, persist the lease in the lease database; and
in response to determining that the lease is invalid based on the live status of the client, deactivate the lease of the unique configuration set in the lease database by adding the unique configuration set back to the pool of different configuration sets.

9. The system of claim 8, wherein the at least one processor is further programmed or configured to:
receive a lease termination request from the client application in response to an indication that the client application is finished using the unique configuration set; and
in response to receiving the lease termination request, deactivate the lease of the unique configuration set in the lease database by adding the unique configuration set back to the pool of different configuration sets.

10. The system of claim 9, wherein the configuration set lease request and the lease termination request are Representational State Transfer (RESTful) Application Programming Interface (API) requests.

11. The system of claim 8, wherein the lease database is at least one of the following: a NoSQL database, an in-memory database, a filesystem store, or any combination thereof.

12. The system of claim 8, wherein the unique configuration set comprises data relating to a computing environment of the client application.

13. The system of claim 8, wherein, when persisting the lease in the lease database, the at least one processor is programmed or configured to:
store a unique instance identifier (ID) wherein the unique instance ID is associated with the unique configuration set and an instance of the client application; and
store a configuration set ID, wherein the configuration set ID is associated with the instance of the client application;
wherein the unique instance ID is associated with the instance of the client application and cannot be associated with any other instances of the client application or with any other client applications.

14. The system of claim 8, wherein, when deactivating the lease of the unique configuration set in the lease database, the at least one processor is programmed or configured to:
add the unique configuration set back to the pool of different configuration sets; and
update the lease database by removing the association between the unique configuration set and the client application, such that the unique configuration set is not associated with any client applications.

15. A computer program product, the computer program product comprising at least one non-transitory computer readable medium including one or more instructions that, when executed by at least one processor, cause the at least one processor to:
receive a configuration set lease request from a client application in response to the client application being launched;
in response to receiving the configuration set lease request, determine a unique configuration set from a pool of different configuration sets;
communicate the unique configuration set to the client application;
activate a lease of the unique configuration set by associating the client application with the unique configuration set in a lease database and removing the unique configuration set from the pool of different configuration sets;
determine a live status of the client application while the lease is active;
in response to determining that the lease is valid based on the live status of the client, persist the lease in the lease database; and
in response to determining that the lease is invalid based on the live status of the client, deactivate the lease of the unique configuration set in the lease database by adding the unique configuration set back to the pool of different configuration sets.

16. The computer program product of claim 15, wherein the one or more instructions further cause the at least one processor to:
receive a lease termination request from the client application in response to an indication that the client application is finished using the unique configuration set; and
in response to receiving the lease termination request, deactivate the lease of the unique configuration set in the lease database by adding the unique configuration set back to the pool of different configuration sets.

17. The computer program product of claim 15, wherein the lease database is at least one of the following: a NoSQL database, an in-memory database, a filesystem store, or any combination thereof.

18. The computer program product of claim 15, wherein the unique configuration set comprises data relating to a computing environment of the client application.

19. The computer program product of claim 15, wherein the one or more instructions that cause the at least one processor to persist the lease in the lease database cause the at least one processor to:
store a unique instance identifier (ID) wherein the unique instance ID is associated with the unique configuration set and an instance of the client application; and
store a configuration set ID, wherein the configuration set ID is associated with the instance of the client application;
wherein the unique instance ID is associated with the instance of the client application and cannot be associated with any other instances of the client application or with any other client applications.

20. The computer program product of claim 15, wherein the one or more instructions that cause the at least one processor to deactivate the lease of the unique configuration set in the lease database cause the at least one processor to:
add the unique configuration set back to the pool of different configuration sets; and
update the lease database by removing the association between the unique configuration set and the client application, such that the unique configuration set is not associated with any client applications.
